(19) United States
(12) Patent Application Publication
(10) Pub. No.: US 2009/0263176 A1
(43) Pub. Date: Oct. 22, 2009

(54) Replaceable Cartridge Dispenser Assembly

(76) Inventors: Robert J. Mileti, Torrington, CT (US); Roger J. Laflamme, West Hartford, CT (US)

Correspondence Address: ST. ONGE STEWARD JOHNSTON & REENS, LLC, 986 BEDFORD STREET, STAMFORD, CT, 06905-5619, US

(21) Appl. No.: 12/427,388

(22) Filed: Apr. 21, 2009

Related U.S. Application Data
(60) Provisional application No. 61/046,463, filed on Apr. 21, 2008.

(51) Int. Cl. B43M 11/06; B65D 37/00

(52) U.S. Cl. 401/184; 222/207

(57) ABSTRACT

In accordance with one embodiment of the present invention, a fluid dispensing device includes a housing having a wall defining an interior compartment, the wall having an opening passing therethrough, and an exit port located therein or thereon, and a replaceable cartridge dispenser assembly disposed within the interior compartment. The replaceable cartridge dispenser assembly includes a fluid reservoir containing a fluid and a metered dispensing pump integrally formed with the fluid reservoir, the metered dispensing pump in fluid communication with the fluid reservoir and with the exit port of the housing and including a button, actuation of which causes metered dispensing of the fluid within the fluid reservoir to the exit port. The button is accessible through the opening in the wall of the housing, and the cartridge assembly, including the fluid reservoir and the metered dispensing pump, is replaceable as a unit such that the housing is reusable.

### CROSS-REFERENCE TO RELATED APPLICATIONS

This patent application claims the benefit, under 35 U.S.C. §119(e), of U.S. Provisional Patent Application Ser. No. 61/046,463, filed on Apr. 21, 2008, which is hereby incorporated by reference herein.

### FIELD OF THE INVENTION

This invention relates generally to product packages that include integrated dispensing devices. More specifically, the present invention relates to consumer devices that have fluid media storage and metering dispensing devices formed as a replaceable cartridge positioned therein that allow for replacing or re-filling of the fluid should the fluid in the storage region be depleted.

### BACKGROUND OF THE INVENTION

Various types of fluid material and media are employed for different purposes throughout commerce and industry. For example, there are various products in the areas of personal care, home care, air care, transportation care and food industries that require a fluid material to be dispensed in some manner from a source of such material. Further, when this material is sold in commerce, it must be contained and stored in some type of container while awaiting use. Ultimately, when that product is used, it must be dispensed from its storage container to the desired location for use.

In the prior art, there are many different types of dispensers that are employed for the delivery of a stored fluid material to its desired location for use. For example, a storage container having a flexible body with a nozzle tip extending therefrom is commonly provided for such a purpose. An example of such use can be seen in the context of a ketchup dispenser, where a user squeezes the container body to urge the fluid material (i.e., ketchup) out from container body and through the nozzle tip to accurately deposit the fluid material at the desired location. In such an application, the amount of fluid that is ultimately delivered is determined by the how much the user actually squeezes the container body. While this method has provided marginally acceptable results, this method also typically yields an erratic fluid volume since more or less fluid material may be delivered on each successive squeeze of the container body. Also, the container must be held upright to avoid leakage because no valves are employed in the fluid nozzle tip.

In another example of a prior art dispensing device, a flexible container is provided that holds a volume of fluid material to be delivered. In an attempt to overcome the leakage issue noted above, a single one-way check valve is provided at the exit port of the flexible container. When the flexible body is squeezed, the material is urged out under pressure through the valve. The difficulty here is that the valve over time becomes partially clogged thereby requiring that the user apply additional pressure to cause the valve to open. As a result, once the valve opens, the additional pressure causes more fluid material to be deposited than the user typically would have desired.

While there are prior add devices, in the form of flexible containers that hold volumes of fluid material to be delivered, that attempt to meet the above identified needs, these devices require that the entire package be disposed of when the supply of media to be dispensed has been depleted. In addition, there are also durable containers, such as liquid soap dispensers, available now that contain a rigid plastic pumping mechanism as part of the container. The exterior of these types of containers can be made to have a pleasing appearance out of crystal or metal. However, these products have their own issues in that they do not fully dispense the liquid soap contained therein as they usually cease to pump as the liquid soap level gets low. In addition, they require the user to re-fill the container with liquid when it gets low. Often requiring the removal of the valve assembly and enduring the ensuing mess of dripping fluid. Finally, the pumping mechanism is built into the outside container, and when it breaks, the container is no longer useful.

As a result of the above noted dispenser issues the consumer marketplace has shied away from devices that, in addition to their primary function, include integrated fluid dispensers such as for example toothbrushes that dispense toothpaste, razors that dispense shaving cream, scrubbers that dispense cleaning fluid, etc. Therefore, there is a need for a fluid dispenser that operates as an accessory feature that is integrated into a primary device. There is a further need for a fluid dispenser to be capable of delivering a metered dose of fluid upon each dispensing operation for expected flow for better application of the fluid material. There is also a need for such a dispenser to be less wasteful than prior art dispensers while also eliminating the need to replace the entire dispenser after the supply of media therein has been depleted.

### SUMMARY OF THE INVENTION

In this regard, the present invention preserves the advantages of prior art fluid dispensing devices. In addition, the present invention provides new advantages not found in currently available devices and overcomes many disadvantages of such currently available devices. The invention is generally directed to a novel and unique dispenser for delivering a substantially equal metered dose of media fluid material upon each dispensing operation while not requiring that the entire dispenser be replaced when the media is depleted. Further, the present invention provides the convenience of combining multiple tools and/or packages into a single an integrated tool.

In accordance with one embodiment of the present invention, a fluid dispensing device includes a housing having a wall defining an interior compartment, the wall of the housing having an opening passing therethrough from an exterior of the housing into the interior compartment, the housing also having an exit port located therein or thereon, and a replaceable cartridge dispenser assembly disposed within the interior compartment of the housing. The replaceable cartridge dispenser assembly includes a fluid reservoir containing a fluid and a metered dispensing pump integrally formed with the fluid reservoir, the metered dispensing pump in fluid communication with the fluid reservoir and with the exit port of the housing and including a button, actuation of which causes metered dispensing of the fluid within the fluid reservoir to the exit port of the housing. The button is accessible through the opening in the wall of the housing, and the cartridge assembly, including the fluid reservoir and the metered dispensing pump, is replaceable as a unit such that the housing is reusable.

In some embodiments, at least a portion of the fluid reservoir is flexible such that the fluid reservoir decreases in size as the fluid is withdrawn therefrom. In accordance with some embodiments, the metered dispensing pump is integrally formed into a wall of the fluid reservoir. In some embodiments, the button comprises a flexible button accessible by a user of the fluid dispensing device, the flexible button at least partially defining a metering chamber in fluid communication with the fluid reservoir and with the exit port of the housing. In certain of these embodiments, the fluid dispensing device further includes an output one-way valve disposed in fluid communication between the metering chamber and the exit port of the housing and permitting unidirectional flow of the fluid from the metering chamber to the exit port of the housing when the flexible button is pressed by the user. In certain embodiments, the fluid dispensing device further includes an intake one-way valve disposed in fluid communication between the metering chamber and the fluid reservoir and permitting unidirectional flow of fluid from the fluid reservoir into the metering chamber thereby filling the metering chamber when the flexible button is released by the user.

In some embodiments, the output one-way valve comprises a check valve. In certain embodiments, the output one-way valve comprises a flap valve. In certain of these embodiments, a flap of the flap valve is integrally formed as part of the flexible button or as part of a wall of the fluid reservoir. In some embodiments, the intake one-way valve comprises a check valve. In certain embodiments, the intake one-way valve comprises a flap valve. In certain of these embodiments, a flap of the flap valve is integrally formed as part of the flexible button or as part of a wall of the fluid reservoir.

In some embodiments, the metering chamber is at least partially defined by the flexible button and at least partially defined by a wall of the fluid reservoir. In some embodiments, the button is transparent or translucent. In certain embodiments, the button has a size and a shape, the opening in the wall of the housing has a size and a shape generally corresponding to the size and shape of the button, and the button extends into and substantially fills the opening in the wall of the housing. In some embodiments, the fluid dispensing device comprises at least one of a scrubber, a toothbrush and a razor.

In accordance with another aspect of the present invention, a replaceable cartridge dispenser assembly is provided for use in connection with a fluid dispensing device comprising a housing having a wall defining an interior compartment, the wall having an opening passing therethrough from an exterior of the housing into the interior compartment, the housing also having an exit port located therein or thereon. The replaceable cartridge dispenser assembly comprises a fluid reservoir containing a fluid and a metered dispensing pump integrally formed into a wall of the fluid reservoir, the metered dispensing pump in fluid communication with the fluid reservoir and with the exit port of the housing and comprising a button, actuation of which causes metered dispensing of the fluid within the fluid reservoir to the exit port of the housing. The button is accessible through the opening in the wall of the housing, and the cartridge assembly, including the fluid reservoir and the metered dispensing pump, is replaceable as a unit such that the housing is reusable.

In accordance with another aspect of the present invention, a fluid dispensing device comprises a housing having a wall defining an interior compartment, the wall of the housing having an opening passing therethrough from an exterior of the housing into the interior compartment, the housing also having an exit port located therein or thereon, and a replaceable cartridge dispenser assembly disposed within the interior compartment of the housing. The replaceable cartridge dispenser assembly comprises a fluid reservoir containing a fluid, at least a portion of the fluid reservoir being flexible such that the fluid reservoir decreases in size as the fluid is withdrawn therefrom, and a metered dispensing pump integrally formed with the fluid reservoir, the metered dispensing pump in fluid communication with the fluid reservoir and with the exit port of the housing. The metered dispensing pump comprises a flexible button at least partially defining a metering chamber in fluid communication with the fluid reservoir and with the exit port of the housing, actuation of the flexible button causing metered dispensing of the fluid within the fluid reservoir to the exit port of the housing, an output one-way valve disposed in fluid communication between the metering chamber and the exit port of the housing and permitting unidirectional flow of the fluid from the metering chamber to the exit port of the housing when the flexible button is pressed by the user, and an intake one-way valve disposed in fluid communication between the metering chamber and the fluid reservoir and permitting unidirectional flow of fluid from the fluid reservoir into the metering chamber thereby filling the metering chamber when the flexible button is released by the user. The button is accessible through the opening in the wall of the housing, and the cartridge assembly, including the fluid reservoir, the metered dispensing pump, the output one-way valve and the intake one-way valve, is replaceable as a unit such that the housing is reusable.

In some embodiments, the output one-way valve comprises a check valve. In certain embodiments, the output one-way valve comprises a flap valve. In certain of these embodiments, a flap of the flap valve is integrally formed as part of the flexible button or as part of a wall of the fluid reservoir. In some embodiments, the intake one-way valve comprises a check valve. In certain embodiments, the intake one-way valve comprises a flap valve. In certain of these embodiments, a flap of the flap valve is integrally formed as part of the flexible button or as part of a wall of the fluid reservoir.

In some embodiments, the metering chamber is at least partially defined by the flexible button and at least partially defined by a wall of the fluid reservoir. In some embodiments, the button is transparent or translucent. In some embodiments, the button has a size and a shape, the opening in the wall of the housing has a size and a shape generally corresponding to the size and shape of the button, and the button extends into and substantially fills the opening in the wall of the housing. In some embodiments, the fluid dispensing device comprises at least one of a scrubber, a toothbrush and a razor.

### BRIEF DESCRIPTION OF THE DRAWINGS

FIG. 1 is an isometric view of a replaceable cartridge dispenser assembly in accordance with an exemplary embodiment of the present invention.

FIG. 2 is an exploded isometric view of a portion of the replaceable cartridge dispenser assembly of FIG. 1.

FIG. 3 is an isometric view of a fluid dispensing device, specifically a scrubber, incorporating the replaceable cartridge dispenser assembly of FIG. 1.

FIG. 4 is a cross-sectional view of the fluid dispensing device incorporating the replaceable cartridge dispenser assembly of FIG. 1, taken along line 4-4 in FIG. 3.

FIG. 5 is an isometric view of a fluid dispensing device, specifically a toothbrush, incorporating the replaceable cartridge dispenser assembly of FIG. 1.

FIG. 6 is a cross-sectional view of the fluid dispensing device incorporating the replaceable cartridge dispenser assembly of FIG. 1, taken along line 6-6 in FIG. 5.

FIG. 7 is an isometric view of a fluid dispensing device, specifically a shaving apparatus, incorporating a replaceable cartridge dispenser assembly in accordance with an exemplary embodiment of the present invention.

FIG. 8 is an exploded isometric view of the fluid dispensing device of FIG. 7.

FIG. 9 is an exploded isometric view of the replaceable cartridge dispenser assembly portion of the fluid dispensing device of FIG. 7.

FIG. 10 is a partially cut-away view of a portion of the replaceable cartridge assembly of the fluid dispensing device taken along line 10-10 of FIG. 8.

### DETAILED DESCRIPTION OF THE INVENTION

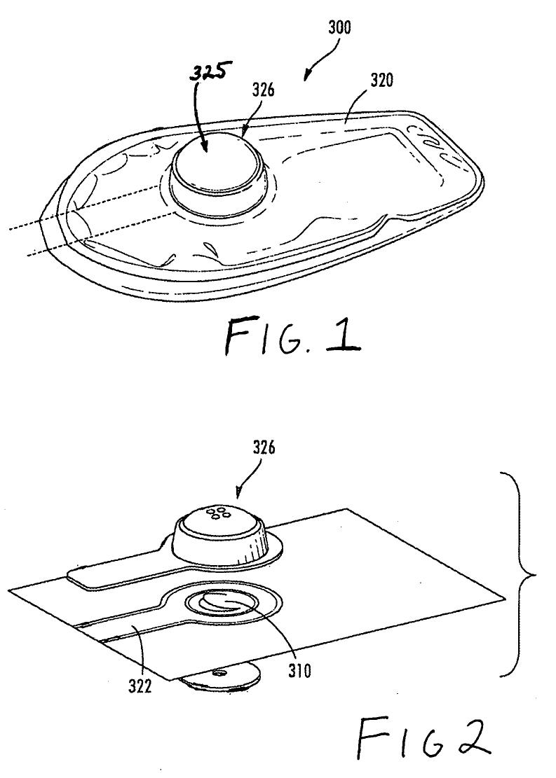

In accordance with one exemplary embodiment of the present invention, and referring first to FIGS. 1 and 2, the fluid dispensing device of the present invention is formed as a modular, replaceable cartridge 300 that has a fluid reservoir in the form of an independently deformable bladder 320 with an integrated metered dispensing pump 325 in fluid communication with the fluid contained therein. The bladder 320 includes a pump 325 and dispensing system that can deliver the media in a dosed and metered fashion. In addition, the dispensing device 300 is formed to be modularly received into another device that itself has an outer exoskeleton that is preferably rigid but may also be semi-rigid. The device is particularly configured to receive the internal dispensing bladder 320 in a cartridge-like fashion. When the internal bladder 320 is depleted of media for dispensing, it may be simply removed and replaced with a new cartridge while leaving the outer rigid exoskeleton for re-use. This substantially saves on cost in that the outer device need not be replaced entirely each time when the supply bladder is empty. The internal bladder may be in any form or configuration to suit the dispensing application at hand.

The metered dispensing pump 325 and valve configuration may be of any form. It is preferred that a flexible metering housing 326 be disposed in fluid communication with the fluid storage region 320 of the internal bladder cartridge with a first one-way valve 310 disposed between the fluid storage region 320 and the flexible metering housing 326. One way flow from the interior fluid storage region 320 of the container fills the predetermined volume of the metering chamber 326 with fluid by vacuum action when the flexible metering housing 326 is depressed and then released. A second valve 322 is in fluid communication with the metering housing output port and permits one-way fluid flow from the metering chamber 326 to a dispenser port in the exoskeleton device when the metering housing 326 is depressed again. Each time the metering housing 326 is depressed a substantially equal volume of fluid is dispensed from the cartridge 300.

The internal deformable bladder of the present invention may reside in the outer exoskeleton housing in many different ways with the pump dispensing mechanism exposed for manipulation by a user. For example, it may snap into the housing where the door of the housing secures the internal bladder cartridge in place during the use. The door may be easily opened to remove the bladder cartridge when it is empty and replace it with a new full bladder cartridge.

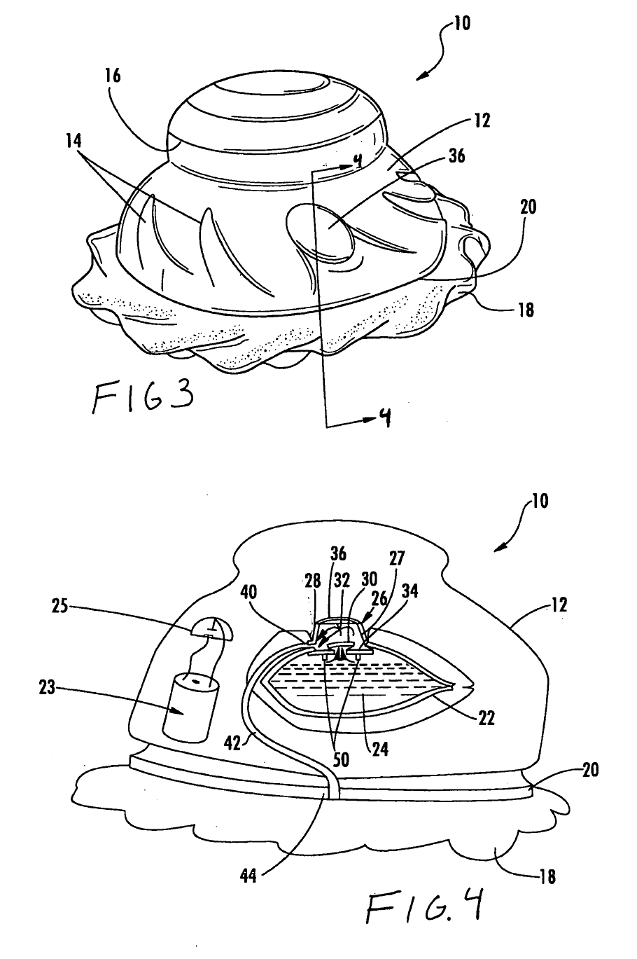

Within the scope of the present invention it is intended that the outer exoskeleton take the form of any accessory device that is used in connection with dispensed fluids. For example, as shown at FIGS. 3 and 4, a scrubber 10 is provided that has an outer shell 12 and a cleaning pad 18 affixed to the bottom 20 thereof. The cartridge dispenser in this application contains a cleaning fluid. The top 16 of the scrubber 10 can be opened when the fluid bladder is emptied to allow replacement with a full bladder thereby extending the life of the scrubber 10 and not requiring replacement.

More specifically, the scrubber 10 includes a main body 12 that is preferably made of a rigid, semi-rigid or soft base material and is configured to be suitable for grasping by a user's hand. In this manner, surface enhancements or gripping contours 14 may be provided to enhance the user's ability to grasp and retain the device 10. A pad member 18 can be seen attached to an engagement surface 20 positioned on one side of the main body 12. Further, as will be described below in connection with FIG. 4, an internal motorized assembly is provided to introduce movement of the pad member 18 relative to the main body 12 of the device 10.

Turning now to FIG. 4, a cross section of the fluid dispensing device 10 of FIG. 3 is shown. In this view it can be seen that the fluid dispensing device 10 includes a fluid storage region 22 that is positioned within the main body 12 and a motorized means 23 for introducing motion of the pad member 18 relative to the main body 12. The present application utilizes the term introducing motion for the movement of the pad member 18 as a general term to describe any mechanically induced movement of the pad member 18 relative to the main body 12. Such a mechanically induced motion may include, but is not limited to, vibration, single directional rotation, alternating rotation, random orbital rotation and linear movement.

As can be seen in this embodiment, a button 25 provided on a side of the main body 12 that when depressed engages the motor 23 to induce movement of the pad member 18. The present invention further includes the possibility that that the motor 23 can be battery driven or driven by a wind-up mechanism using any known device in the art. It can also be seen that the engagement surface 20 may be a separate component that itself is movable relative to the main body 12 of the dispenser 10 with the pad member 18 being affixed thereto. In this arrangement, the motor 23 serves to induce movement of the engagement surface 20 relative to the main body 12 where the movement of the engagement surface 20 in turn causes movement of the pad member 18 affixed thereto.

It can also be seen that a fluid storage region 22 is provided within the main body. The fluid storage region 22 is configured as a reservoir for containing a cleaning fluid 24. Further, a metered dosing pump 26 is provided in fluid communication with the fluid storage region 22. The metered dosing pump 26 is selectively operable to deliver, upon actuation by the user, a measured amount of the cleaning fluid 24 contained therein. Still referring to FIG. 4, an example of the internal construction of the metering pump 26 in relation to the fluid storage region 22 the dispenser 10 of the present invention is shown. The fluid storage region 22 contains a volume of fluid material 24 therein. The outer wall of the fluid storage region 22 is preferably made of a flexible material, such as plastic or nylon. Thus, as fluid material 24 is evacuated from within the fluid storage region 22, it will collapse gradually for a compact structure.

The metering pump 26 is in fluid communication with the fluid storage region 22. The metering pump 26 includes a metering housing 27 provided at a first opening 28 in the fluid storage region 22. The metering housing 27 includes an intake one-way valve 30, such as a check valve, to pull fluid 24 from the fluid storage region 22 into the metering chamber 32 of a predetermined size. Any type of valve can be used to suit the given application. The intake valve 30 is positioned in a base plate 34 of the metering housing 27. Thus, fluid 24 can only flow in one way from the fluid storage region 22 into the metering chamber 32. The metering chamber 32 is defined by a flexible membrane 36 in the form of a button or bulb that is accessible and manipulatable on the exterior surface of the main body 12 of the device 10 through an opening provided in the main body 12 (as shown in FIG. 3). The button 36 is preferably clear to provide an indicator to the consumer when the metered dosage of fluid material 24 is ready for delivery. An output valve 40 is provided in fluid communication with the metering chamber 32 of the metering housing 27. Thus, the fluid residing in the metering chamber 32 can only exit through the output valve 40. Also, a fluid conduit 42 is provided to direct the exit of the fluid 24. In this particular case to an opening 44 in the engagement surface 20 adjacent the pad member 18. In accordance with the present invention, each press of the flexible membrane 36 causes a metered amount of fluid 24 to be forced through the opening 44 to provide the desired measured dosing application. This button/membrane 36 can be placed anywhere on the device, as needed.

Still referring to FIG. 4, the operation of the metered dosing pump 26 is further explained. The button 36 of the metering housing 27 is depressed to initiate a vacuum operation. More specifically, when the button 36 is further released, fluid 24 is pulled from the fluid storage region 22 into the metering chamber 32 which is configured to be of a certain known volume. The act of releasing the button 36 fills the metering chamber 32 to substantial capacity. Thus, a metered amount of fluid material 24 is contained within the metering chamber 32 in preparation for delivery. The size of the metering chamber 32 can be selected according to the type of fluid material 24 to be dispensed, the application therefor and the desired dosage volume. A further depression of the button 36 urges the measured volume of fluid 24 within the metering chamber 32 to exit out through the output valve 40 of the metering housing 27. This known amount of fluid material 24 is then routed into through the fluid conduit 42 and out through the opening 44 engagement member 20.

In most cases, the fluid 24 is then deposited onto the rear surface of the pad member 18 although it is also within the scope of the present invention to route the fluid conduit 42 so that the fluid 24 is deposited into the pad member 18 or onto the front surface of the pad member 18.

It can also be seen in FIG. 4 that a number of standoff legs 50 emanate downwardly from the base plate 34 of the metering housing 27. These legs 50 prevent the base plate 34 from completely bottoming out against the walls of the fluid storage region 22 thereby blocking flow of fluid material 24 into the intake valve 30. The standoff legs 50 are particularly useful when the volume of fluid material 24 left in the fluid storage region 22 is running low and the fluid storage region 22 is becoming relative flat in configuration. In this situation, there is a possibility that the aforesaid bottoming out may occur. However, the use of the standoff legs 50 prevents this from occurring. It should also be appreciated that while standoff legs 50 are shown, other spring biased or spring like structures may be used to accomplish the same function and should be considered interchangeable with the standoff legs 50.

As mentioned above, the top 16 of the scrubber 10 can be opened when the fluid bladder is emptied to allow replacement with a full bladder thereby extending the life of the scrubber 10 and not requiring replacement. More specifically, the entire cartridge assembly, including the fluid storage region 22 and the metering pump 26 (with all of its associated components), may be removed and replaced as a unit.

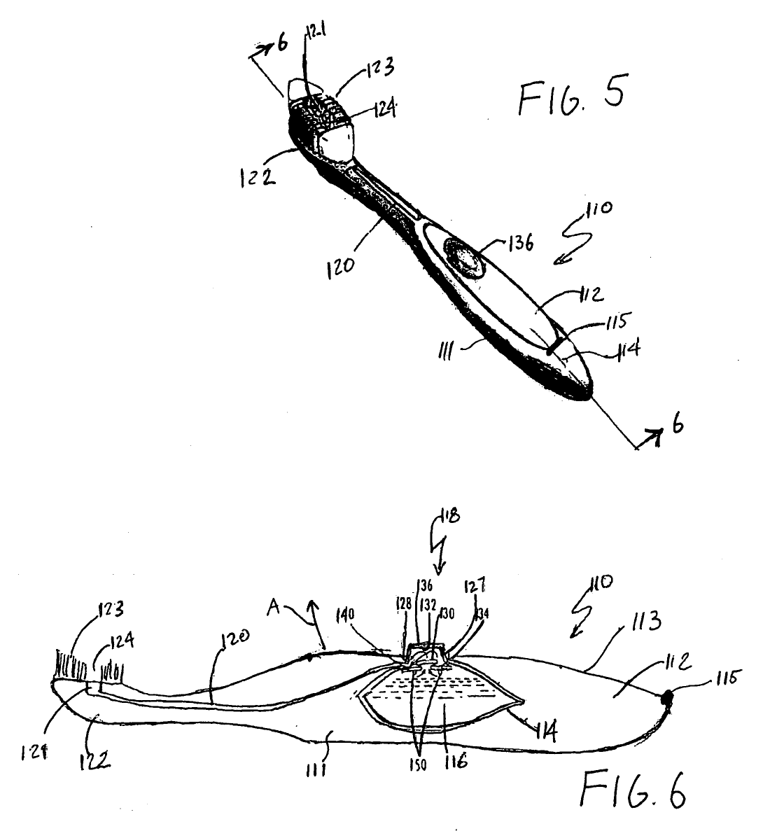

Referring now to FIGS. 5 and 6 a toothbrush 110 including a toothpaste dispenser, in the form of a cartridge assembly according to the present invention, is shown. The toothbrush 110 has a rigid outer housing 111 with a panel 113 that can be opened about a pivot 115 (indicated by arrow A) to replace the toothpaste dispenser once it is empty. In operation, the toothpaste dispenser discharges toothpaste into the head 122 of the toothbrush 110.

More specifically, the toothbrush with integrated dispenser is shown and generally illustrated at 110 in FIG. 5. Generally, the toothpaste dispensing toothbrush 110 includes a main body 112 that has a hollow cavity therein that serves to contain a bladder or fluid storage region 114. The fluid storage region 114 in turn contains a volume of fluid 116 such as toothpaste. In addition, the toothbrush 110 can be seen to include a metered dosing pump 118 that controls the flow of toothpaste 116 from the fluid storage region 114 and through a conduit 120 that exits an output port 121 adjacent the toothbrush head 122.

The operation of the metered dosing pump 118 will be discussed in detail below. Further, the toothbrush 110 can be seen to include a plurality of bristles 123 extending outwardly from the head 122 for use in cleaning the user's teeth. To facilitate dispensing of the fluid 116 it is preferred that a region of no bristles or a reduced number of bristles 124 is provided at the exit 121 of the fluid conduit 120 to form a reservoir space within the toothbrush 110 bristles 123 for receipt of the dispensed toothpaste 116. Further, it should be appreciated that while a fluid storage region 114 and a metered dosing pump 118 is provided within the main body 112 of the toothbrush 110, the functional shape of the toothbrush 110 is maintained so that the added features do not interfere with the operation thereof.

Turning now to FIG. 6, a cross section of the fluid dispensing toothbrush 110 is shown. In this view it can be seen that the fluid dispensing toothbrush 110 includes a fluid storage region 114 that is positioned within the main body 112. The fluid storage region 114 is configured as a reservoir for containing a fluid 116 such as toothpaste. Further, a metered dosing pump 118 is provided in fluid communication with the fluid storage region 114. The metered dosing pump 118 is selectively operable to deliver, upon actuation by the user, a measured amount of the toothpaste 116 contained therein. Still referring to FIG. 6, the internal construction of the metering pump 118 in relation to the fluid storage region 114 the toothbrush 110 is shown. The fluid storage region 114 contains a volume of toothpaste 116 therein. The outer wall of the fluid storage region 114 is preferably made of a flexible material, such as plastic or nylon. Thus, as fluid material 116 is evacuated from within the fluid storage region 114, it will collapse gradually for a compact structure.

The metering pump 118 is in fluid communication with the fluid storage region 114. The metering pump 118 includes a metering housing 127 is provided at a first opening 128 in the fluid storage region 114. The metering housing 127 includes an intake one-way valve 130, such as a check valve, to pull fluid 116 from the fluid storage region 114 into the metering chamber 132 of a predetermined size. Any type of valve can be used to suit the given application. The intake valve 130 is positioned in a base plate 134 of the metering housing 127. Thus, fluid 116 can only flow in one way from the fluid storage region 114 into the metering chamber 132. The metering chamber 132 is defined by a flexible membrane 136 in the form of a button or bulb that is accessible and manipulatable on the exterior surface of the main body 112 of the device 110. The button 136 is preferably clear to provide an indicator to the consumer when the metered dosage of fluid material 116 is ready for delivery. An output valve 140 is provided in fluid communication with the metering chamber 132 of the metering housing 127. Thus, the fluid residing in the metering chamber 132 can only exit through the output valve 140. Also, a fluid conduit 120 is provided to direct the exit of the fluid 116. In this particular case to an opening 121 in the head 122 of the toothbrush 110 adjacent the bristles 123. In accordance with the present invention, each press of the flexible membrane 136 causes a metered amount of fluid 116 to be forced through the opening 121 to provide the desired measured dosing application. This button/membrane 136 can be placed anywhere on the device, as needed.

Still referring to FIG. 6, the operation of the metered dosing pump 118 is further explained. The button 136 of the metering housing 127 is depressed to initiate a vacuum operation. More specifically, when the button 136 is further released, fluid 116 is pulled from the fluid storage region 114 into the metering chamber 132 which is configured to be of a certain known volume. The act of releasing the button 136 fills the metering chamber 132 to substantial capacity. Thus, a metered amount of fluid material 116 is contained within the metering chamber 132 in preparation for delivery. The size of the metering chamber 132 can be selected according to the type of fluid material 116 to be dispensed, the application therefor and the desired dosage volume. A further depression of the button 136 urges the measured volume of fluid 116 within the metering chamber 132 to exit out through the output valve 140 of the metering housing 127. This known amount of fluid material 116 is then routed into through the fluid conduit 120 and out through the opening 121 in the toothbrush 110 head 122.

In most cases, the fluid 116 is then deposited onto the rear of the bristles 123 although it is also within the scope of the present invention to route the fluid conduit 120 so that the fluid 116 is deposited into the bristles 123 or onto the front surface of the bristles 123.

It can also be seen in FIG. 6 that a number of standoff legs 150 emanate downwardly from the base plate 134 of the metering housing 127. These legs 150 prevent the base plate 134 from completely bottoming out against the walls of the fluid storage region 114 thereby blocking flow of fluid material 116 into the intake valve 130. The standoff legs 150 are particularly useful when the volume of fluid material 116 left in the fluid storage region 114 is running low and the fluid storage region 114 is becoming relative flat in configuration. In this situation, there is a possibility that the aforesaid bottoming out may occur. However, the use of the standoff legs 150 prevents this from occurring. It should also be appreciated that while standoff legs 150 are shown, other spring biased or spring like structures may be used to accomplish the same function and should be considered interchangeable with the standoff legs 150.

As mentioned above, a panel 113 of the rigid outer housing 111 can be opened about a pivot 115 (indicated by arrow A) when the fluid bladder is emptied to allow replacement with a full fluid bladder thereby extending the life of the toothbrush 110 and not requiring replacement. More specifically, the entire cartridge assembly, including the fluid storage region 114 and the metering pump 118 (with all of its associated components), may be removed and replaced as a unit.

Referring now to FIGS. 7 through 10 a shaving apparatus 210 including a shaving treatment dispenser, in the form of a cartridge assembly according to the present invention, is shown. The shaving treatment dispensing razor 210 includes a main body 212 that contains a bladder or pouch 214 or other storage chamber therein that contains a volume of shaving treatment. A pumping mechanism 216 controls the flow of the shaving treatment from the pouch 214 through a conduit 218 which exits at a directed point near the shaving head 220. It is envisioned that each press of the button 222 of the pumping mechanism 216 dispenses a specific predetermined amount of shaving treatment to a location on the skin or on or near the blades for use by the user. Thus, a metered dose of shaving treatment can be delivered through the conduit 218 as desired by the user. The vacuum pumping method of the present invention (described in more detail below) assures that the shaving treatment is delivered consistently regardless of orientation and/or how much pressure is applied by the user and for how long, and the pumping mechanism 216 is not affected by gravity. This pumping method also assures the relatively complete evacuation of the contents of the pouch 214, which is important as each pouch 214 will by nature of its size contain a fairly small volume of shaving treatment. Any pumping method that would not be able to substantially evacuate the pouch 214 would as such be quite wasteful on a percentage basis.

The pouch 214 containing the shaving treatment is a replaceable self-contained module made at least partially from flexible packaging materials. The pouch 214 may be sealed, welded or molded from standard Olefin based films or any other flexible sheet material suitable for packing liquids or gels. In some embodiments (discussed in more detail below), only a flexible portion of the pouch 214 is formed of such materials, with a rigid or semi-rigid portion of the pouch 214 being formed from some other material, preferably a polymeric material, by one or more of a variety of processes, such as molding, vacuum forming or any of numerous other fabrication methods. The pumping mechanism 216 device is integrated within or on the body of the pouch 214 itself. The pumping mechanism 216 may thus be positioned at any point on the main body 212 where it can be easily activated by the user, but the flow of shaving treatment can then be directed through an exit conduit 218 so that it may be applied to the user's skin or the blades (or any other location) where desired. The fact that the pumping mechanism 216 is integrated into or onto the pouch 214 is in many cases critical in allowing the dispensing pouch 214 to fit within and work within the small framework of a razor 210, and to allow the position of the dosing button 222 to be convenient for the user. The exit conduit 218 allows the flow of shaving treatment to be directed where needed, independent of the most convenient location for the pump dosing button 222 itself.

It is also possible, although certainly not necessary, that the pumping mechanism can dose and deliver a given volume of shaving treatment material in adjustable increments. For example, a single press of the dosing button delivers this custom amount of material. In that connection, it is possible that the pumping mechanism can be modified so that the amount of material delivered by each pump of the dosing button can be custom selected by the user. For example, the pump mechanism can be adjustable by use of a dial or other structure to adjustably limited the throw of the dosing button. In other words, an adjustable structure, such as a twistable dial and stop configuration, can be used to control how far the dosing button of the pump can actuate downwardly, thereby limiting and controlling the amount of material delivered in a given press of the dosing button. Thus, the user can custom control the flow of material to the razor. The foregoing structure is one of many different structures and configurations that can be employed to provide adjustable volume delivery of the treatment material in accordance with the present invention.

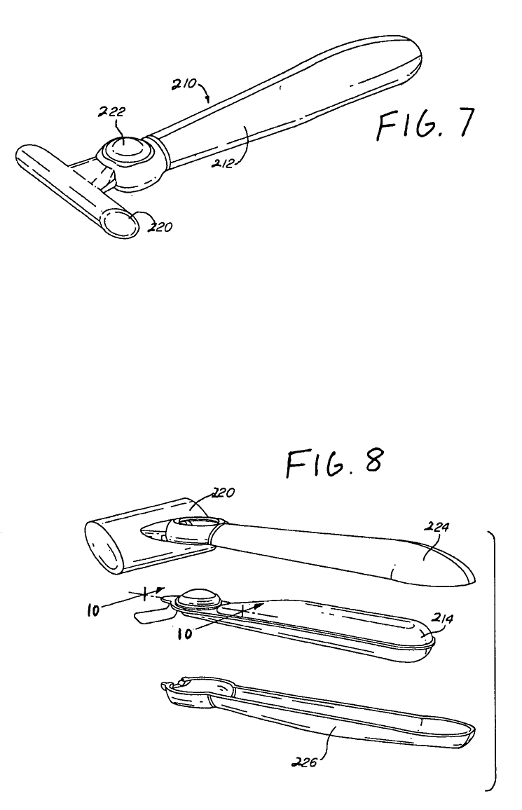

There are a number of methods for affixing the pouch 214 within or to the main body 212 of the razor 210. FIGS. 7 and 8 show one embodiment of integration of the metered dosing pouch 214 within a fairly typical handle razor with blade. In FIG. 8 the pouch 214 is secured within a clam-shell opening in the main body 212, which is formed of an upper handle portion 224 and a lower handle portion 226. The metered dispensing button 222 protrudes through an opening in the upper handle portion 224 so that it may easily be activated by the user. A shaving treatment can be dispensed while shaving by pressing the dosing button 222. The shaving treatment can be directed by means of the exit conduit 218 so that the shaving treatment is applied to the skin near to the blades.

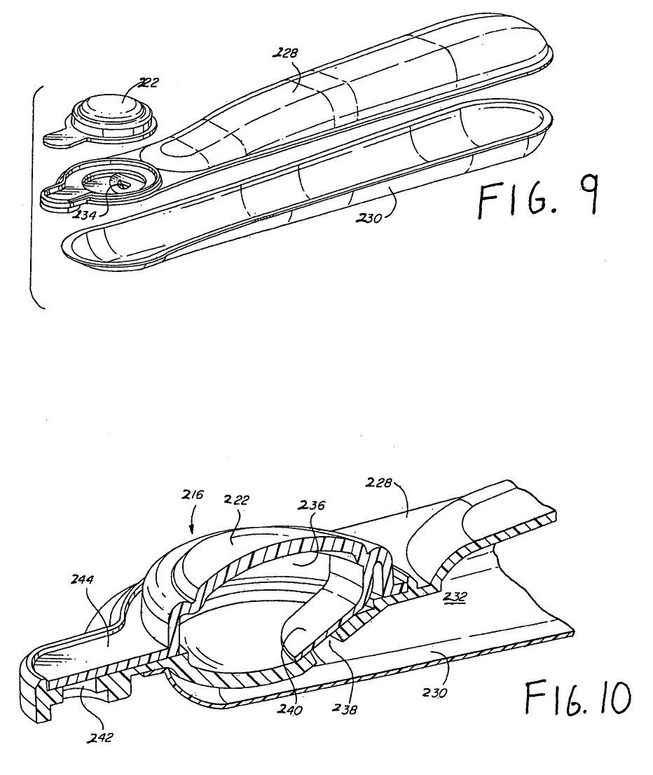

Referring now to FIGS. 9 and 10 in particular, one embodiment of pouch 214, also referred to herein as an integrated mechanism for the dispensing of shaving treatments, is shown in greater detail. Pouch 214 is formed of two portions, an upper portion 228, which may be formed from a rigid or semi-rigid material, such as molded plastic, and a lower portion 230, sealed or otherwise attached to the upper portion 228 to define therebetween a reservoir 232 that contains a volume of shaving treatment therein. The lower portion 230 of the pouch 214 is preferably made of a flexible material, such as plastic or nylon, such that as shaving treatment is evacuated from within the reservoir 232, the lower portion 230 of the pouch 214 will collapse gradually into the more rigid upper portion 228.

A flexible metering button 222 is provided in a corresponding area of the upper portion 228 of the pouch 214 in the vicinity of an opening 234 therethrough. The flexible metering button 222 and the corresponding portion of the upper portion 228 of the pouch 214 thus define a metering chamber 236, with the opening 234 being located between the metering chamber 236 and the reservoir 232. The pumping mechanism 216 further includes an intake one-way valve 238, such as a check valve, to pull shaving treatment from the reservoir 232 of the pouch 214 into the metering chamber 236. Any type of valve can be used to suit the given application, but it is preferable that the intake one-way valve 238 be formed as a flap valve employing a flap of material 240 integrated with the flexible metering button 222. Thus, shaving treatment can only flow in one way from the reservoir 232 into the metering chamber 236. The button 222 may be transparent or translucent to provide an indicator to the user when the metered dosage of shaving treatment is ready for delivery.

An output one-way valve 242, which may also be a one-way check valve, is provided in fluid communication with the metering chamber 236 of the pumping mechanism 216. Thus, the shaving treatment residing in the metering chamber 236 can only exit through the output one-way valve 242. The output one-way valve 242 is also in communication with the output conduit 218 to direct the exit of shaving treatment as described above. Again, any type of valve can be used to suit the given application, but it is preferable that the output one-way valve 242 be formed as a flap valve employing a flap of material 244 integrated with the flexible metering button 222.

Still referring to FIGS. 9 and 10, the operation of the pumping mechanism 216 is further explained. The metering button 222 of the pumping mechanism 216 is depressed to initiate a vacuum operation. More specifically, when the button 222 is released, shaving treatment is pulled from the reservoir 232 of the pouch 214 through the intake one-way valve 238 into the metering chamber 236 which is configured to be of a certain known volume. The act of releasing the button 222 fills the metering chamber 236 to substantial capacity. Thus, a metered amount of shaving treatment is contained within the metering chamber 236 in preparation for delivery. The size of the metering chamber 236 can be selected according to the type of shaving treatment to be dispensed and the application therefor and the desired dosage volume.

A further depression of the button 222 urges the measured volume of shaving treatment within the metering chamber 236 to exit out through the output one-way valve 242 of the pumping mechanism 216. This known amount of shaving treatment is then routed to the shaving head 220 for use or through the fluid conduit 218, as seen in FIG. 7. When the button 222 is again released, additional shaving treatment is pulled from the reservoir 232 of the pouch 214 through the intake one-way valve 238 into the metering chamber 236 and is ready for delivery.

The razor 210 is designed so that the pouch 214, with integrated pumping mechanism 216, can be easily popped out and replaced when empty or even with a different shaving treatment depending upon the desires of the user. For example, as described above, and as best seen in FIG. 8, the main body 212 may have a clam-shell design, with an upper handle portion 224 and a lower handle portion 226 being separable by the user so that the pouch 214 mat be conveniently replaced.

While a scrubber, a toothbrush and a razor are particularly depicted, the inventive concept of the present invention is directed to the use of a modular cartridge arrangement that employs a fluid storage region and pump that are replaceable as a unit when the fluid storage region is depleted. As such the figures herein are merely examples and the device could take virtually any form or shape as the application at hand required.

It should be appreciated by those skilled in the art that various changes and modifications can be made to the illustrated embodiments without departing from the spirit of the present invention. All such modifications and changes are intended to be covered within the scope of the present invention disclosure.

What is claimed is:

1. A fluid dispensing device comprising:
a housing having a wall defining an interior compartment, the wall of said housing having an opening passing therethrough from an exterior of said housing into the interior compartment, said housing also having an exit port located therein or thereon; and
a replaceable cartridge dispenser assembly disposed within the interior compartment of said housing, said replaceable cartridge dispenser assembly comprising:
a fluid reservoir containing a fluid; and
a metered dispensing pump integrally formed with said fluid reservoir, said metered dispensing pump in fluid communication with said fluid reservoir and with the exit port of said housing and comprising a button, actuation of which causes metered dispensing of the fluid within said fluid reservoir to the exit port of said housing;
wherein said button is accessible through the opening in the wall of said housing; and
wherein said cartridge assembly, including said fluid reservoir and said metered dispensing pump, is replaceable as a unit such that said housing is reusable.

2. The fluid dispensing device of claim 1 wherein at least a portion of said fluid reservoir is flexible such that said fluid reservoir decreases in size as the fluid is withdrawn therefrom.

3. The fluid dispensing device of claim 1 wherein said metered dispensing pump is integrally formed into a wall of said fluid reservoir.

4. The fluid dispensing device of claim 1 wherein said button comprises a flexible button accessible by a user of said fluid dispensing device, the flexible button at least partially defining a metering chamber in fluid communication with said fluid reservoir and with the exit port of said housing.

5. The fluid dispensing device of claim 4 further comprising an output one-way valve disposed in fluid communication between the metering chamber and the exit port of said housing and permitting unidirectional flow of the fluid from the metering chamber to the exit port of said housing when said flexible button is pressed by the user.

6. The fluid dispensing device of claim 5 further comprising an intake one-way valve disposed in fluid communication between the metering chamber and said fluid reservoir and permitting unidirectional flow of fluid from said fluid reservoir into the metering chamber thereby filling the metering chamber when said flexible button is released by the user.

7. The fluid dispensing device of claim 6 wherein said output one-way valve comprises a check valve.

8. The fluid dispensing device of claim 7 wherein said output one-way valve comprises a flap valve.

9. The fluid dispensing device of claim 8 wherein a flap of the flap valve is integrally formed as part of said flexible button or as part of a wall of said fluid reservoir.

10. The fluid dispensing device of claim 6 wherein said intake one-way valve comprises a check valve.

11. The fluid dispensing device of claim 10 wherein said intake one-way valve comprises a flap valve.

12. The fluid dispensing device of claim 11 wherein a flap of the flap valve is integrally formed as part of said flexible button or as part of a wall of said fluid reservoir.

13. The fluid dispensing device of claim 4 wherein the metering chamber is at least partially defined by said flexible button and at least partially defined by a wall of said fluid reservoir.

14. The fluid dispensing device of claim 1 wherein said button is transparent or translucent.

15. The fluid dispensing device of claim 1 wherein said button has a size and a shape, wherein the opening in the wall of said housing has a size and a shape generally corresponding to the size and shape of said button, and wherein said button extends into and substantially fills the opening in the wall of said housing.

16. The fluid dispensing device of claim 1 wherein said fluid dispensing device comprises at least one of a scrubber, a toothbrush and a razor.

17. A replaceable cartridge dispenser assembly for use in connection with a fluid dispensing device comprising a housing having a wall defining an interior compartment, the wall having an opening passing therethrough from an exterior of the housing into the interior compartment, the housing also having an exit port located therein or thereon, said replaceable cartridge dispenser assembly comprising:
a fluid reservoir containing a fluid; and
a metered dispensing pump integrally formed into a wall of said fluid reservoir, said metered dispensing pump in fluid communication with said fluid reservoir and with the exit port of said housing and comprising a button, actuation of which causes metered dispensing of the fluid within said fluid reservoir to the exit port of said housing;
wherein said button is accessible through the opening in the wall of said housing; and
wherein said cartridge assembly, including said fluid reservoir and said metered dispensing pump, is replaceable as a unit such that said housing is reusable.

18. A fluid dispensing device comprising:
a housing having a wall defining an interior compartment, the wall of said housing having an opening passing therethrough from an exterior of said housing into the interior compartment, said housing also having an exit port located therein or thereon; and
a replaceable cartridge dispenser assembly disposed within the interior compartment of said housing, said replaceable cartridge dispenser assembly comprising:
a fluid reservoir containing a fluid, at least a portion of said fluid reservoir being flexible such that said fluid reservoir decreases in size as the fluid is withdrawn therefrom; and
a metered dispensing pump integrally formed with said fluid reservoir, said metered dispensing pump in fluid communication with said fluid reservoir and with the exit port of said housing and comprising a flexible button at least partially defining a metering chamber in fluid communication with said fluid reservoir and with the exit port of said housing, actuation of said flexible button causing metered dispensing of the fluid within said fluid reservoir to the exit port of said housing;
an output one-way valve disposed in fluid communication between the metering chamber and the exit port of said housing and permitting unidirectional flow of the fluid from the metering chamber to the exit port of said housing when said flexible button is pressed by the user;
an intake one-way valve disposed in fluid communication between the metering chamber and said fluid reservoir and permitting unidirectional flow of fluid from said fluid reservoir into the metering chamber thereby filling the metering chamber when said flexible button is released by the user;
wherein said button is accessible through the opening in the wall of said housing; and
wherein said cartridge assembly, including said fluid reservoir, said metered dispensing pump, said output one-way valve and said intake one-way valve, is replaceable as a unit such that said housing is reusable.

19. The fluid dispensing device of claim 18 wherein said output one-way valve comprises a check valve.

20. The fluid dispensing device of claim 19 wherein said output one-way valve comprises a flap valve.

21. The fluid dispensing device of claim 20 wherein a flap of the flap valve is integrally formed as part of said flexible button or as part of a wall of said fluid reservoir.

22. The fluid dispensing device of claim 18 wherein said intake one-way valve comprises a check valve.

23. The fluid dispensing device of claim 22 wherein said intake one-way valve comprises a flap valve.

24. The fluid dispensing device of claim 23 wherein a flap of the flap valve is integrally formed as part of said flexible button or as part of a wall of said fluid reservoir.

25. The fluid dispensing device of claim 18 wherein the metering chamber is at least partially defined by said flexible button and at least partially defined by a wall of said fluid reservoir.

26. The fluid dispensing device of claim 18 wherein said button is transparent or translucent.

27. The fluid dispensing device of claim 18 wherein said button has a size and a shape, wherein the opening in the wall of said housing has a size and a shape generally corresponding to the size and shape of said button, and wherein said button extends into and substantially fills the opening in the wall of said housing.

28. The fluid dispensing device of claim 18 wherein said fluid dispensing device comprises at least one of a scrubber, a toothbrush and a razor.
